(19) United States
(12) Patent Application Publication
(10) Pub. No.: US 2020/0383359 A1
(43) Pub. Date: Dec. 10, 2020

(54) SAVORY CLUSTER SNACK FOOD

(71) Applicant: Frito-Lay Trading Company GmbH, Berne (CH)

(72) Inventors: Maja SZCZUCINSKA, Leicester (GB); Dimitris LYKOMITROS, Leicester (GB); James WILLIAMS, Leicester (GB)

(21) Appl. No.: 16/821,852

(22) PCT Filed: Sep. 26, 2018
(86) PCT No.: PCT/EP2018/025252

§ 371 Date: Mar. 17, 2020

(30) Foreign Application Priority Data
Sep. 26, 2017 (GB) 1715547.4

(51) Int. Cl. A23L 7/126; A23L 25/00; A23L 29/00; A23L 29/30

(52) U.S. Cl. CPC A23L 7/126; A23L 25/30; A23V 2250/154; A23L 29/30; A23V 2250/06; A23L 29/04

(57) ABSTRACT

The present invention discloses a snack food product comprising a plurality of savory clusters, each cluster comprising a dry mixture comprising at least one grain, at least one seed and at least one nut, the mixture being coated with a binder, wherein the binder comprises or consists of a mixture of a soluble dietary fibre component and a low dextrose equivalent (DE) sugar syrup, the low dextrose equivalent (DE) sugar symp having a maximum dextrose equivalent (DE) of 40, in a weight ratio within the range of from 30:70 to 70:30, and each cluster comprises from 65 to 85 wt % of the mixture and from 15 to 35 wt % of the binder, each wt % value being the based on the total weight of the cluster. The snack food provides a satisfying snack between meals or in place of a meal.

### BACKGROUND OF THE INVENTION

### Technical Field

The present invention relates to an improved snack food product and more particularly to a snack food product that incorporates a savory cluster component to provide a good source of fibre and protein.

### Description of Related Art

One example of a snack food mixture is known colloquially as trail mix. Trail mix is a mixture of nuts, such as peanuts or cashews, and partially dried fruit, like raisins or dried cranberries. Many of these snack mixtures contain granola.

Granola is also incorporated into snack bars, sometimes with different components such as nuts, other grains, or dried fruit. These granola bars may be eat as a snack or as a meal replacement.

Often, the granola used in snack mixtures or snack bars is seasoned or mixed with other components to achieve an overall sweet taste. Nut and/or granola clusters have conventionally been made with the use of binding slurry consisting mainly of sugars and/or maltodextrins. The slurry is blended with the dry components (e.g. nuts and/or cereal pieces) at a temperature significantly higher than the Glass Transition Temperature (Tg) of the slurry, shaped into clusters/bars and cooled to below Tg, so that the binder forms a glass with a crispy (non-chewy) texture. This can be achieved in two ways: 1) reducing the temperature to below Tg as in the case of sugar-based binders, or 2) increasing the Tg by removing plasticizers present in the slurry (e.g. evaporating solvents/water in dryer). Sugar based slurries have the advantage of not requiring an additional drying operation, but the product is inherently sweet and glossy, something not desirable in savory applications.

WO-A-2017/078519 discloses sweet-type cereal bars including a binder syrup comprising soluble dietary fibre chosen from fructo-oligosaccharide and/or inulin, which have an intrinsic sweet taste, and insoluble dietary fibre from the same plant source. WO-A-00/056171 discloses cereal bars including binders comprising sugar, milk solids and a binding agent such as a polysaccharide or gum. US-A-2012/0269939 discloses cereal binder compositions including milk/whey protein and a sugar syrup. WO-A-2011/019690 discloses a food binder syrup comprising polydextrose, crystall fructose and glycerin. WO-A-01/97633 discloses nutrient clusters with a binder comprising nutritive carbohydrate sweetening agents, and soluble fibre from fructo-oligosaccharides. US-A-2014/0093635 discloses a savory, as opposed to sweet, granola snack food.

However, there is still a need to provide a savory snack food comprising clusters which have the combination of desired nutritional content, low cost and ease of manufacture to produce a light and crispy texture, with minimized shiny glaze.

The present invention is accordingly directed towards providing an improved savory snack food product.

### SUMMARY OF THE INVENTION

The present invention provides a snack food product comprising a plurality of savory clusters, each cluster comprising a dry mixture comprising at least one grain, at least one seed and at least one nut, the mixture being coated with a binder, wherein the binder comprises or consists of a mixture of a soluble dietary fibre component and a low dextrose equivalent (DE) sugar syrup, the low dextrose equivalent (DE) sugar syrup having a maximum dextrose equivalent (DE) of 40, in a weight ratio within the range of from 30:70 to 70:30, and each cluster comprises from 65 to 85 wt % of the mixture and from 15 to 35 wt % of the binder, each wt % value being the based on the total weight of the cluster.

The preferred embodiments of the snack food product of the present invention are high in protein and rich in fibres. Furthermore, the preferred embodiments of the snack food product of the present invention are high in wholegrains, seeds and nuts. The preferred embodiments of the snack food product of the present invention are designed to provide a satisfying snack between meals or in place of a meal.

The snack food product may be presented to the consumer in a number of forms. In one embodiment, the snack food product is a loose snack mixture or a snack bar. In the loose snack mixture the clusters are typically substantially spherical or hemispherical. In the loose snack mixture the clusters are typically “bite-size” maximum dimension of from 1.5 to 2.5 cm.

By providing a dry mixture comprising at least one grain, at least one seed and at least one nut, the clusters are not only multi-textured, they can also be multi-colored. There is no requirement to add coloring agents to the clusters. There is no requirement to add artificial flavoring agents to the clusters. Any seasonings may be derived from, or comprise, natural ingredients.

The binder can provide a glaze with minimum shine on the clusters. Such a minimum shine is consistent with an expectation by the consumer that the product would have no or low sweetness and would be savory.

The preferred embodiments of the snack food product of the present invention provide a snack food product, in the form of clusters, the clusters consisting of puffed and/or extruded grains, nuts and seeds, which are rich in fibre and a source of protein. Preferably, the grains are wholegrains, i.e. comprising the whole endosperm, bran and germ of the grain.

The soluble dietary fibre is soluble in water or other aqueous liquids.

In one preferred embodiment the binder is a soluble corn fibre component, which comprises soluble corn fibre, mixed with low dextrose equivalent (DE) sugar syrup, which typically comprises or is a low dextrose equivalent (DE) glucose syrup. The soluble corn fibre is soluble in water or other aqueous liquids.

The soluble dietary fibre component may be incorporated into the low dextrose equivalent (DE) sugar syrup as a dry ingredient, which in the binder is suspended in the sugar syrup. Alternatively, and preferably, the soluble dietary fibre component may be incorporated into the binder as a liquid ingredient, in which the soluble dietary fibre is suspended or dissolved in a carrier. The carrier may be water or a sugar-containing composition. The carrier containing the soluble dietary fibre is then blended with the sugar syrup.

The soluble corn fibre component, which is commercially available, may typically comprise from 70 to 100 wt % soluble corn fibre on a dry weight basis, and/or may be in the form of a liquid which typically comprises from 50 to 85 wt % soluble corn fibre based on the total weight of the component. Such a binder mixture, of soluble dietary fibre and low dextrose equivalent (DE) sugar, e.g. glucose, syrup, can achieve a snack food product which is neutral in taste, or when spices are added e.g. chilli pepper, black pepper, etc., is a savory product.

The snack food product of the preferred embodiments of the present invention can deliver a crispy, light and airy texture as a result of using the specific binder system in the weight % range of the present invention. The snack food product of the preferred embodiments of the present invention can also deliver a multi-texture experience as a result of using the specific dry mixture comprising at least one grain, at least one seed and at least one nut. The snack food product of the preferred embodiments of the present invention is not overly filling, allowing for prolonged enjoyment.

The preferred embodiments of the snack food product of the present invention use a binder, including a soluble dietary fibre component, such as soluble corn fibres, which is additionally combined with a sugar syrup, typically a low DE glucose and/or fructose syrup having a maximum dextrose equivalent (DE) of 40 and preferably a dextrose equivalent (DE) within the range of 25 to 40. Preferably the binder consists of the soluble dietary fibre component, such as soluble corn fibres, and the low DE sugar syrup having a maximum dextrose equivalent (DE) of 40, preferably a dextrose equivalent (DE) within the range of 25 to 40, which is typically a low DE glucose and/or fructose syrup.

The present invention is at least partly predicated on the finding by the present inventors that mixing soluble dietary fibres with low DE glucose and/or fructose syrup allows to balance (i) the nutritional content of the product, so that the product is rich in fibre, (ii) at an acceptable product cost, since typical commercially available glucose and/or fructose syrups, in particular low dextrose equivalent (DE) glucose and/or fructose syrups, have a cost which is approximately one half of the cost of typical commercially available soluble fibre components for use as binders together with (iii) low sweetness to achieve a savory snack food cluster in which the dry mixture components are bound by the blend of the soluble dietary fibre and glucose and/or fructose syrup in the binder system; and (iv) in which the binder has a desired fibre content.

In the preferred embodiments of the snack food product of the present invention, the dry mixture ingredients, such as puffed and/or extruded grains, preferably wholegrains, mixed with nuts and seeds, are bound together by the blend of soluble dietary, e.g. corn, fibre and low DE glucose and/or fructose syrup, which can be baked at a relatively high temperature 160-170° C. for a period of from 8-10 minutes (based on prototyping results) allowing to achieve, in either loose clusters or shaped bars, a desired light and crispy texture, with minimized shiny glaze and positive nutritionals, namely rich in fibre and a good source of protein.

### DETAILED DESCRIPTION OF THE INVENTION

In accordance with the present invention, the snack food product comprises a plurality of savory clusters. As used herein, the term “savory cluster” means an agglomeration of a plurality of pieces held together by a binder that imparts little to no sweetness. The snack food product may be presented to the consumer in a number of forms. In one embodiment, the snack food product is a snack mixture comprising a plurality of loose clusters. In another embodiment, the snack food product is a snack bar, which has been formed to a desired shape.

Each cluster comprises a dry mixture comprising at least one grain, at least one seed and at least one nut.

The mixture is coated with a binder which comprises, or preferably consists of, a mixture of a soluble dietary fibre component and a sugar syrup, which sugar syrup has a maximum dextrose equivalent (DE) of 40, in a weight ratio within the range of from 30:70 to 70:30. Typically, the sugar syrup has a dextrose equivalent (DE) within the range of from 25 to 40. The sugar syrup is preferably a glucose syrup, a fructose syrup, or a blend thereof. Preferably, the binder comprises a mixture of a soluble corn fibre and a glucose syrup.

In one embodiment, the sugar syrup is a glucose syrup which as a dextrose equivalent (DE) within the range of from 27 to 34. In another embodiment, the sugar syrup is a glucose syrup which as a dextrose equivalent (DE) within the range of from 34 to 38.

Each cluster comprises from 65 to 85 wt % of the mixture and from 15 to 35 wt % of the binder, and further optionally comprises from 65 to 80 wt % of the mixture and from 20 to 35 wt % of the binder, each wt % value being the based on the total weight of the cluster.

In the preferred embodiments of the present invention, the soluble dietary fibre comprises or consists of soluble corn fibre. The soluble corn fibre is soluble in water or other aqueous liquids.

Preferably, the soluble corn fibre component used to form the binder is in liquid form and typically comprises from 70 to 100 wt % soluble corn fibre on a dry weight basis, and/or comprises from 50 to 85 wt % soluble corn fibre based on the total weight of the soluble corn fibre component.

Preferably, the binder comprises a mixture of a soluble corn fibre component and a glucose syrup in a weight ratio within the range of from 40:60 to 60:40, for example in a weight ratio within the range of about 50:50.

The soluble dietary fibre component may be incorporated into the binder as a dry ingredient, which in the binder is suspended in the sugar syrup. The dry ingredient may typically comprise from 70 to 100 wt % soluble dietary fibres, for example soluble corn fibre. A commercially available dry soluble corn fibre component is sold under the trade name Promitor® by Tate and UK, and may have a soluble corn fibre content of 70, 85 or 90 wt %.

Alternatively, and preferably, the soluble dietary fibre component may be incorporated into the binder as a liquid ingredient, in which the soluble dietary fibre is suspended or dissolved in a carrier. The carrier containing the soluble dietary fibre is then blended with the sugar syrup. Typically, the carrier may be water or a sugar-containing composition. The liquid ingredient may typically comprise from 50 to 85 wt %, optionally from 70 to 85 wt %, soluble dietary fibres, for example soluble corn fibre. A commercially available liquid soluble corn fibre component is sold under the trade name Promitor® by Tate and Lyle plc, UK, and may have a soluble corn fibre content of 70 or 85 wt %.

In the preferred embodiments of the present invention, the binder has a total sugar content which is from 4 to 12 wt %, more preferably from 4 to 6 wt %, of the total weight of the snack food product.

In the preferred embodiments of the present invention, each cluster comprises from 5 to 30 wt %, optionally 10 to 30 wt %, puffed and/or extruded grains based on the total weight of the cluster. Typically, the puffed and/or extruded grains comprise millet, quinoa, rice, wheat or amaranth, or any mixture of any two or more thereof. Preferably, the puffed and/or extruded grains are in the form of whole unbroken grains.

In the preferred embodiments of the present invention, each cluster comprises from 10 to 40 wt % nuts based on the total weight of the cluster. As used herein, the term “nut” is used in the culinary sense and includes any large, oily kernel found within a shell and used in food. The nuts used herein may be oil-roasted, dry-roasted, raw, blanched, unblanched, salted or unsalted, full-fat or partially defatted. Typically, the nuts comprise cashew, walnut, almond, hazelnut, pecan, pistachio, Brazil nut, or peanut, or any mixture of any two or more thereof. Preferably, the nuts are in the form of chopped or broken nuts.

In the preferred embodiments of the present invention, each cluster comprises from 5 to 30 wt % seeds based on the total weight of the cluster. As used herein, the term “seed” is used in the culinary sense and includes any small, oily kernel found within a shell and used in food. Typically, the seeds comprise pumpkin, sunflower, chia, soybean, flax, sesame or quinoa, or any mixture of any two or more thereof. Preferably, the seeds are in the form of whole seeds, which are unbroken.

In the preferred embodiments of the present invention, each cluster further comprises from 5 to 20 wt % grain flakes based on the total weight of the cluster. Typically, the grain flakes comprise oat flakes, wheat flakes, barley flakes or quinoa flakes, or any mixture of any two or more thereof.

In the preferred embodiments of the present invention, each cluster further comprises from 5 to 20 wt % dried fruit based on the total weight of the cluster. The types of dried fruit pieces that may be used in accordance herein are osmotically dehydrated, vacuum fried pieces of fruit or a freeze-dried pieces of fruit. Examples of dried fruit are cranberry, apricot, raisin, fig, date, blackcurrant, blackberry, apple and banana, or any mixture of any two or more thereof, optionally the fruit being in the form of comminuted pieces

In the preferred embodiments of the present invention, no seasoning or oil is applied topically to the cluster. Optionally, seasoning such as salt, pepper or at least one spice, or any mixture of any two or more thereof, may be blended within the mixture.

In the preferred embodiments of the present invention, each cluster may optionally further comprise one or more nutritional supplements. As used herein, the term “nutritional supplement” is a material, generally a vitamin or a mineral, added to a product to restore the nutritional contents degraded from processing. Examples of nutritional supplements that may be used are B-vitamins, antioxidant vitamins (i.e., A-vitamins or C-vitamins), or minerals such as iron, magnesium, phosphorus, potassium or zinc.

In the preferred embodiments of the present invention, the snack food product comprises from 10 to 20 wt % fibre, optionally from 13 to 15 wt % fibre. Preferably, the fibre is provided by the dry mixture and the soluble dietary fibre in the binder. In the preferred embodiments of the present invention, the snack food product comprises from 10 to 20 wt % protein, optionally from 13 to 15 wt % protein. Preferably, the protein is provided by the dry mixture. The protein content of the clusters may be increased to 20 to 30 wt % by adding soy protein isolates or soy protein concentrates to the clusters.

In the preferred embodiments of the present invention, the snack food product comprises up to 30 wt % fat and less than 4% saturated fatty acids.

Preferably, the snack food product also comprises from 4 to 12 wt %, more preferably from 4 to 6 wt %, added sugar, i.e. sugar that is added as a refined component, for example in the binder, soluble dietary fibre component, or sugar syrup, rather than sugar present in another ingredient, e.g. in any nut, grain or seed. Preferably, less than 20% of the energy in the snack food product is provided by such added sugar.

The snack food product comprises at least 20 wt % of nut, grain and/or seed constituents.

Typically, the at least one grain comprises at least one wholegrain, and preferably the at least one grain comprises at least 50 wt % wholegrain, based on the weight of the at least one grain.

The snack food product of the present invention is typically rich in wholegrains, fibres and nuts, designed to provide a satisfying snack between meals or in place of a meal.

The snack food product of the present invention is not only nutritious, but it also scores well in consumer tests.

The present invention is described further with reference to the following non-limiting Examples.

### EXAMPLE 1

A snack mixture was prepared in accordance w th the present invention. The composition is shown in Table 1.

TABLE 1

| | Wt % |
|---|---|
| Dry Mixture forming | |
| Cluster Base | |
| Almonds | 11 |
| Cashews | 11 |
| Walnuts | 11 |
| Sunflower seeds | 11 |
| Pumpkin seeds | 11 |
| Puffed millet | 11 |
| Binder | |
| Soluble corn fibre | 17 |
| Low DE glucose syrup | 17 |
| Seasoning | |
| Salt | 1 |
| Total | 100 wt % |

### EXAMPLE 2

A snack mixture was prepared in accordance with the present invention. The composition is shown in Table 2.

TABLE 2

| | Wt % |
|---|---|
| Dry Mixture forming | |
| Cluster Base | |
| Almonds | 10 |
| Peanuts | 10 |
| Sunflower seeds | 10 |
| Chia seeds | 4 |
| Oat flakes | 8 |
| Puffed millet | 22 |
| Binder | |
| Soluble corn fibre | 17 |
| Low DE glucose syrup | 17 |
| Seasoning | |
| Salt | 1 |
| Total | 100 wt % |

### EXAMPLE 3

A snack mixture was prepared in accordance with the present invent composition is shown in Table 3.

TABLE 3

| | Wt % |
|---|---|
| Dry Mixture forming | |
| Cluster Base | |
| Almonds | 9 |
| Cashews | 9 |
| Peanuts | 9 |
| Sunflower seeds | 14 |
| Sesame seeds | 5 |
| Puffed quinoa | 19 |
| Binder | |
| Soluble corn fibre | 17 |
| Low DE glucose syrup | 17 |
| Seasoning | |
| Salt | 1 |
| Total | 100 wt % |

While this invention has been particularly shown and described with reference to preferred embodiments, it will be understood by those skilled in the art that various changes in form and detail may be made therein without departing from the scope of the invention as defined by the appended claims.

1.-37. (canceled)

38. A snack food product comprising a plurality of savory clusters, each cluster comprising a dry mixture comprising at least one grain, at least one seed and at least one nut, the mixture being coated with a binder, wherein the binder comprises a mixture of a soluble dietary fiber component and a low dextrose equivalent (DE) sugar syrup, in a weight ratio within the range of from 30:70 to 70:30, wherein the low dextrose equivalent (DE) sugar syrup has a maximum dextrose equivalent (DE) of 40 and each cluster comprises from 65 to 85 wt % of the mixture and from 15 to 35 wt % of the binder, each wt % value being the based on the total weight of the cluster.

39. A snack food product according to claim 38 wherein the soluble dietary fiber component comprises from 70 to 100 wt % soluble dietary fiber on a dry weight basis based on the total weight of the component.

40. A snack food product according to claim 38 wherein the soluble dietary fiber component comprises the soluble dietary fiber suspended or dissolved in a carrier.

41. A snack food product according to claim 40 wherein the carrier is water or a sugar-containing composition.

42. A snack food product according to claim 38 wherein the binder has a total sugar content which is from 4 to 12 wt % of the total weight of the snack food product.

43. A snack food product according to claim 38 wherein each cluster comprises from 5 to 30 wt % puffed and/or extruded grains based on the total weight of the cluster.

44. A snack food product according to claim 38 wherein each cluster comprises from 10 to 40 wt % nuts based on the total weight of the cluster.

45. A snack food product according to claim 38 wherein each cluster comprises from 5 to 30 wt % seeds based on the total weight of the cluster.

46. A snack food product according to claim 38 wherein each cluster further comprises from 5 to 20 wt % grain flakes based on the total weight of the cluster.

47. A snack food product according to claim 38 wherein each cluster further comprises from 5 to 20 wt % dried fruit based on the total weight of the cluster.

48. A snack food product according to claim 38 wherein the savory clusters are free of any topically coated seasoning.

49. A snack food product according to claim 38 wherein the savory clusters are free of any topically coated oil.

50. A snack food product according to claim 38 wherein the savory clusters are loose, and optionally have a maximum dimension of from 1.5 to 2.5 cm.

51. A snack food product according to claim 38 wherein the snack food product comprises from 10 to 20 wt % fiber, optionally from 13 to 15 wt % fiber.

52. A snack food product according to claim 51 wherein the fiber is provided by the dry mixture and the soluble dietary fiber in the binder.

53. A snack food product according to claim 38 wherein the snack food product comprises from 10 to 20 wt % protein.

54. A snack food product according to claim 38 wherein the snack food product comprises up to 30 wt % fat and less than 4% saturated fatty acids.

55. A snack food product according to claim 38 wherein the snack food product comprises from 4 to 12 wt % added sugars, the added sugars being present in the binder.

56. A snack food product according to claim 38 wherein the at least one grain comprises at least one wholegrain.

57. A snack food product according to claim 56 wherein the at least one grain comprises at least 50 wt % wholegrain, based on the weight of the at least one grain.
